(19) United States
(12) Patent Application Publication
(10) Pub. No.: US 2021/0194579 A1
(43) Pub. Date: Jun. 24, 2021

(54) PORTABLE INFORMATION DATA TRANSMITTING DEVICE AND SYSTEM USING VISIBLE LIGHT COMMUNICATION

(71) Applicant: YUYANG DNU CO., LTD., Hwaseong-si, Gyeonggi-do (KR)

(72) Inventors: Sangok KIM, Seoul (KR); Byungoh KIM, Suwon-si (KR); Dongsik KIM, Siheung-si (KR); Sang-ho YOON, Suwon-si (KR)

(73) Assignee: Yuyang Dnu Co., Ltd., Hwaseong-si, Gyeonggi-do (KR)

(21) Appl. No.: 16/093,231

(22) PCT Filed: Feb. 24, 2017
(86) PCT No.: PCT/KR2017/002087

§ 371 Date: Oct. 12, 2018

(30) Foreign Application Priority Data
Apr. 12, 2016 (KR) 10-2016-0045031

(51) Int. Cl. H04B 10/116; H04B 10/114; H04B 10/516; H04B 10/50

(52) U.S. Cl. CPC H04B 10/116; H04B 10/1149; F21V 33/0052; H04B 10/502; H04B 10/1141; H04B 10/516

(57) ABSTRACT

The present disclosure in some embodiments provides a portable information data transmitting device capable of storing at least one piece of information data, and transmitting, by using a plurality of light emitting elements, a visible light signal including a part or all of the information data to a display device positioned within a preset communication range, thereby enabling the information data to be more efficiently provided to a user.

### TECHNICAL FIELD

The present disclosure in some embodiments relates to a portable information data transmitting device and a system using visible light communication.

### BACKGROUND

The statements in this section merely provide background information related to the present disclosure and do not necessarily constitute prior art.

Publicity or presentation events for products or ideas are given more and more frequently at different venues. To that end, various methods are mobilized, which include a visualized presentation often involving a beam projector.

Generally, a beam projector, which is an imaging device with a lamp for projecting light onto a screen to embody a super-large picture, allows a large audience to watch the product demonstration or other presentations on screen.

However, a conventional beam projector, which is either fixed at a specific place or too bulky and heavy to be portable, stops at providing some limited service and use to conference room jobs, more or less.

In order to solve this deficiency, more recent beam projectors with enhanced portability are available for purchase. However, the portable beam projectors have their projection lens exposed to the outside and susceptible to be scratched during transport. This requires a protective cover as an additional component. Further, the high cost of portable beam projectors can hardly justify underutilized projector service, degrading their efficiency.

The portable beam projectors have their main purpose to allow the user to more efficiently get information data anywhere. Therefore, new cost-effective equipment is needed for providing the complete information data provision function as with the portable beam projectors, in a more efficient manner.

### DISCLOSURE

### Technical Problem

The present disclosure in some embodiments seeks to provide a portable information data transmitting device capable of storing at least one piece of information data, and transmitting, by using a plurality of light emitting elements, a visible light signal including a part or all of the information data to a display device positioned within a preset communication range, thereby enabling the information data to be more efficiently provided to a user.

### SUMMARY

At least one aspect of the present disclosure provides a portable information data transmitting device includes a memory, a light emitting unit and a control unit. The memory is configured to store at least one piece of information data. The light emitting unit is configured to include a plurality of light emitting elements, and to transmit visible light signals including some or all of the information data to a display device located within a predetermined communication range by using the light emitting elements. The control unit is configured to control the light emitting elements for causing the visible light signals to be transmitted to the display device.

Another aspect of the present disclosure provides a system for displaying information data by using visible light communication includes a portable information data transmitting device and a display device. The portable information data transmitting device is configured to store at least one piece of information data, and to include a plurality of light emitting elements for transmitting visible light signals including some or all of the information data. The display device is configured to receive the visible light signals from the portable information data transmitting device, and to display the information data included in the visible light signals to a user.

### Advantageous Effects

According to some embodiments, a portable information data transmitting device can store at least one piece of information data, and transmit, by using a plurality of light emitting elements, a visible light signal including a part or all of the information data to a display device positioned within a preset communication range, thereby enabling the information data to be more efficiently provided to a user.

Further, according to some embodiments, a portable information data transmitting device not only implements the information data transmission function, but also doubles as the function of flashlight for the best practical usability of the device.

### BRIEF DESCRIPTION OF THE DRAWINGS

FIG. 1 is a diagram of an information data display system according to at least one embodiment of the present disclosure.

FIG. 2 is a schematic block diagram of a portable information data transmitting device according to at least one embodiment.

FIG. 3 is a flowchart of a first method performed by a portable information data transmitting device, for providing information data according to at least one embodiment.

FIG. 4 is a flowchart of a second method performed by a portable information data transmitting device, for providing information data according to at least one embodiment.

FIG. 5 is a flowchart of a third method performed by a portable information data transmitting device, for providing information data according to at least one embodiment.

FIG. 6 is a flowchart of a fourth method performed by a portable information data transmitting device, for providing information data according to at least one embodiment.

REFERENCE NUMERALS

| | |
|---|---|
| 110: Portable information data transmitting | |
| device | |
| 120: Display device | |
| 200: Memory | 210: Light emitting unit |
| 212: Light emitting element | 220: Control unit |
| 230: Operation unit | 240: Display unit |
| 250: Signal modulation unit | |
| 400: collectordevice | 410: secondary coil |

### DETAILED DESCRIPTION

Hereinafter, some embodiments of the present disclosure will be described in detail with reference to the accompanying drawings.

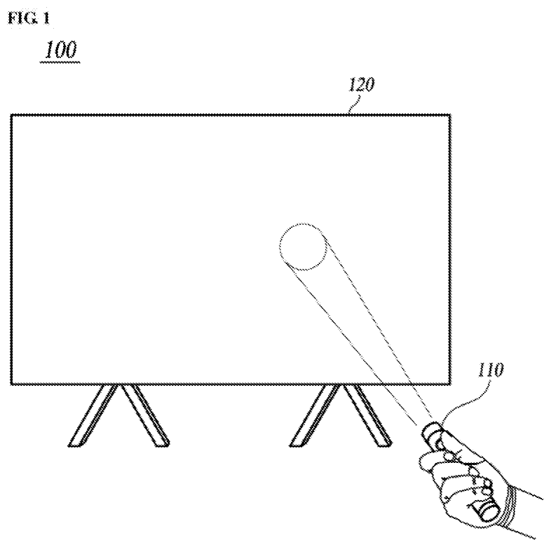

FIG. 1 is a diagram of an information data display system according to at least one embodiment of the present disclosure. An information data display system 100 according to at least one embodiment may be implemented not only in a room such as a conference room, but also in various outdoor spaces for promoting or announcing products or ideas. In addition, the information data display system 100 according to at least one embodiment offers information service providing service by utilizing visible light communication for allowing the user to receive information data more efficiently.

The information data display system 100 according to some embodiments includes a portable information data transmitting device 110 and a display device 120.

The portable information data transmitting device 110 is a device having a function of transmitting information data to the peripheral display device 120 by using visible light communication. Visible light communication is a technology of using light of a light emitting element such as a light emitting diode (LED) which emits light by a semiconductor, as a communication light source. The light used for visible light communication is visible light having a wavelength of 780 nm to 380 nm, and due to its properties, it can provide both of lighting function and communication function.

The portable information data transmitting device 110 according to some embodiments includes a storage area in which data is stored, for example, a memory 200, and utilizes the memory 200 for storing information data for transmission to the display device 120. Here, the information data is preferably, but not necessarily limited to, a document or an image for presentation of a product or an idea and the like. In some embodiments, such information data are limited to no particular types.

The portable information data transmitting device 110 transmits its stored information data to the display device 120 by using visible light. When the portable information data transmitting device 110 detects the presence of the display device 120 within a preset communication range, it sends the relevant display device 120 a visible light signal including some or all of the information data stored in the portable information data transmitting device 110. For this purpose, the portable information data transmitting device 110 is implemented in a form that includes a plurality of light emitting elements 212 as constituent elements.

The portable information data transmitting device 110 may further have at least one external selection means which is operated to transmit, to the display device 120 in various methods of provision, the information data stored in the portable information data transmitting device 110.

The portable information data transmitting device 110 may further have a visible light reception module including a light detection diode, so as to transmit as well as receive a visible light signal including information data to and from the display device 120.

The portable information data transmitting device 110 may cause the light-emitting element 212 to emit light of a predetermined intensity, when occasion demands repurposing thereof from an information data transmitter to a flashlight. To this end, it is preferable for the portable information data transmitting device 110 to be implemented in a flashlight shape, although the present disclosure is not limited thereto.

The display device 120 is a device that receives a visible light signal from the portable information data transmitting device 110 and displays information data included in the visible light signal to the user. To achieve this, the display device 120 is implemented in a form including a large number of pixels for outputting information data along with at least one visible light receiving module.

It is preferable that the display device 120 is a screen, but it is not necessarily limited thereto. Although not shown in FIG. 1, the display device 120 may further include an auxiliary device which is interlocked with the display device 120 and adapted to assist, for example, a change in status of information data displayed on the display device 120.

The display device 120 may further include at least one visible light transmission module for transmitting a visible light signal including information data to the portable information data transmitting device 110.

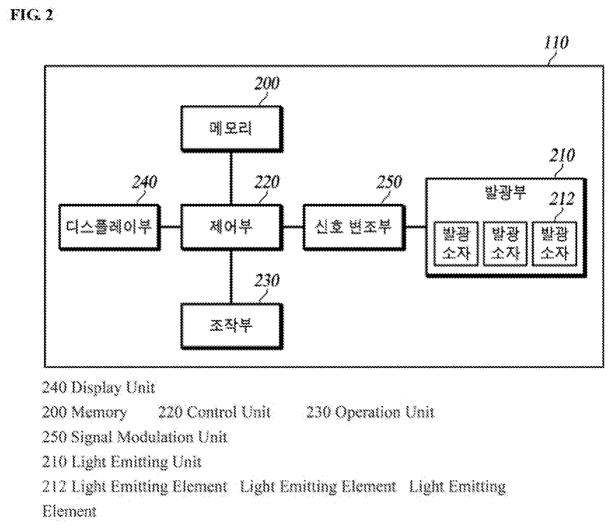

FIG. 2 is a schematic block diagram of a portable information data transmitting device according to at least one embodiment.

The portable information data transmitting device 110 according to some embodiments includes the memory 200, the light emitting unit 210, a control unit 220, an operation unit 230, a display unit 240 and a signal modulation unit 250. Here, the constituent elements included in the portable information data transmitting device 110 are not necessarily limited to the explicit elements. For example, the portable information data transmitting device 110 according to some embodiments may be implemented without including the display unit 240 as a constituent element. In some implementations, the portable information data transmitting device 110 additionally includes a photodetecting diode that receives a visible light signal from the outside, converts the received visible light signal into an electric signal, and provides the same.

The memory 200 stores at least one piece of information data to be transmitted to the display device 120. The memory 200 stores the information data based on a preset storage structure which may be a hierarchical structure in which parent and child nodes are sequentially mapped.

The memory 200 is preferably implemented by at least one of a Secure Digital (SD) memory, micro SD memory, microchip, but it is not necessarily so limited. When implemented by SD memory or micro SD memory, the memory 200 is inserted into a slot (not shown) provided in the portable information data transmitting device 110, thereby being electrically connected to the portable information data transmitting device 110.

When implemented by the microchip, the memory 200 is provided inside the portable information data transmitting device 110, and transmits the information data from an external device (not shown) via a connecting means such as a cable. At this time, the cable may be implemented such that its tip employs Universal Serial Bus (USB) or micro USB.

The light emitting unit 210 is a module that converts electric energy into light energy. The light emitting unit 210 according to some embodiments includes a plurality of light emitting elements 212, converts information data into a visible light signal by using the installed light emitting elements 212, and send the same to the display device 120. In detail, the light emitting unit 210 blinks or flashes through the light emitting elements 212 at least 200 times per second to convert electric signals generated by modulating the information data by the signal modulation unit 250 into visible light signals and to transmit the converted visible light signals to the display device 120.

When the portable information data transmitting device 110 is used as a flashlight, the light emitting unit 210 causes the light emitting elements 212 to emit light at a predetermined intensity. The light emitting element 212 is preferably an LED, but it is not necessarily limited thereto.

The control unit 220 controls the operation of the light emitting elements 212. The control unit 220 according to some embodiments controls the operation of the light emitting elements 212 so that the portable information data transmitting device 110 serves as a flashlight or an information data transmitting device.

In the case where the portable information data transmitting device 110 performs as a flashlight, the control unit 220 controls power supplied to the light emitting elements 212 so that they emit light of a predetermined intensity.

When the portable information data transmitting device 110 performs as an information data transmitting device, the control unit 220 controls the light emitting elements 212 so that they transmit a visible light signal including some or all of the information data to the display device 120.

The control unit 220 is responsive to the operation of at least one selection means provided in the operation unit 230 for causing the information data to be provided to the display device 120 in different methods of provision.

The following will describe various methods performed by the control unit 220 for providing the information data to the display device 120.

In a first provision method, the control unit 220 controls the light emitting element 212 for causing a visible light signal including all information data stored in the memory 200 to be transmitted to the display device 120.

According to the first provision method, the user can receive all the information data stored in the portable information data transmitting device 110 more simply and quickly.

In a second provision method, the control unit 220 generates information on the list of the information data stored in the memory 200, controls the light emitting elements 212 for causing the visible light signal including the list information is to be transmitted to the display device 120.

Then, the control unit 220 controls, upon receiving a selection signal of specific information data in the list information from the display device 120, the light emitting elements 212 to transmit a visible light signal including the specific information data to the display device 120. It is preferable that the portable information data transmitting device 110 receives the selection signal by using the visible light communication from the display device 120, but it is not necessarily so limited.

In the second provision method, when the user can not get the accurate list information of the information data stored in the memory 200, for example, when the portable information data transmitting device 110 is not installed with the display unit 240, the list information can be directly visually checked through the display device 120. This allows the user to selectively receive only the desired information data from the portable information data transmitting device 110.

In a third data provision method, the control unit 220 confirms the number of times of activating the selection means, and it accordingly generates specific information data having a storage ordinal number corresponding to the cardinal number of times of activating the selection means, among the information data stored in the memory 200. The control unit 220 controls the light emitting elements 212 to transmit a visible light signal including the generated specific information data to the display device 120.

The third provision method is effective for when the user is accurately informed of the information data stored in the memory 200 to more quickly get necessary information data from the portable information data transmitting device 110.

A fourth provision method may be performed only when the display unit 240 is installed in the portable information data transmitting device 110.

In the fourth provision method, the control unit 220 controls so that related information to the information data stored in the memory 200 is displayed via the display unit 240. Here, the related information to the information data may be, but not limited to the title, creator, size, save date and time of the information data, etc. For example, the related information to the information data may be any information as long as it is unique information specific to the information data of interest, making the latter distinguishable from other information data.

According to some embodiments, the control unit 220 generates an image corresponding to the related information displayed through the display unit 240, and controls the light emitting element 212 to cause a visible light signal including the image to be transmitted to the display device 120. This enables the user of the portable information data transmitting device 110 to watch the related information to the information data in an enlarged view on the display device 120.

When the control unit 220 receives a selection signal of specific related information out of the related information to the information data displayed via the display unit 240, it controls the light emitting element 212 for causing the visible light signal including the information data corresponding to the specific related information to be transmitted to the display device 120. The selection signal of the specific related information may be generated in response to the operation of the selection means, and may be generated in response to the operation of a separate operation button provided.

In the fourth provision method, the user directly confirms the related information to the information data stored in the memory 200 with the user's own eyes via the display unit 240, thereby making specific information data selectable so that the user is presented with information data of actual interest more efficiently.

The operation unit 230 has selection means for controlling the operation of the portable information data transmitting device 110. Such selection means is preferably provided on the outer surface of the portable information data transmitting device 110, and is preferably implemented in the form of buttons, but is not necessarily limited thereto.

In some embodiments, the selection means may be provided corresponding to each function provided by the portable information data transmitting device 110. For example, the portable information data transmitting device 110 according to some embodiments includes a plurality of function buttons for selecting one of methods of providing information data in the operation unit 230, and a mode switching button for repurposing the portable information data transmitting device 110.

In another embodiment, the portable information data transmitting device 110 has only one selection means in the operation unit 230, and the provided selection means can be operated to select and perform the respective functions offered by the portable information data transmission apparatus 110. In this case, it is preferable that the selection means is implemented by a button which can be rotated and pushed so that the single button enables to select and perform various functions, although the selection means is not so limited.

The display unit 240 displays the related information to the information data stored in the memory 200, to the user. The display unit 240 can display, under the control by the control unit 220, the related information to the information data stored in the memory 200 in various forms.

The signal modulation unit 250 provides electric signals by modulating the information data. Here, the electric signal is desirably a digital signal for high-speed switching to be performed by the light emitting elements 212 included in the light emitting unit 210. In addition, it is preferable that the signal modulation unit 250 generates electric signals by modulating the information data through frequency shift keying (FSK), although it is not necessarily limited thereto.

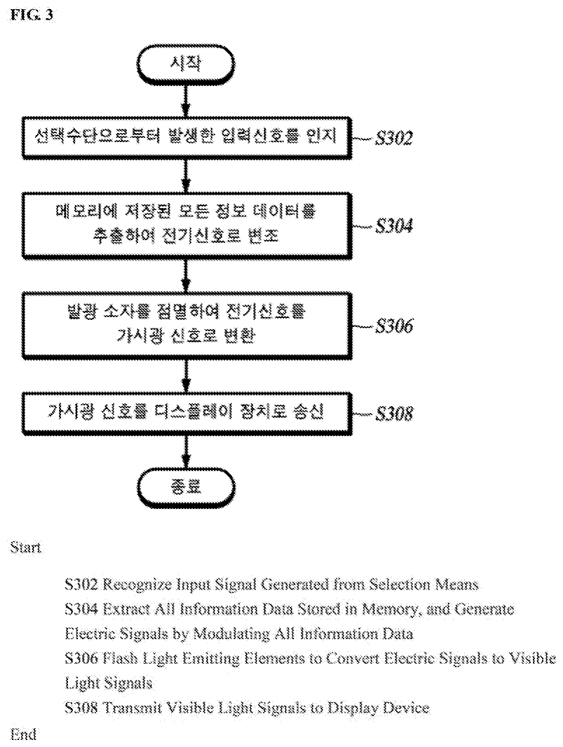

FIG. 3 is a flowchart of a first method performed by a portable information data transmitting device, for providing information data according to at least one embodiment.

The portable information data transmitting device 110 recognizes an input signal generated from selection means provided on the portable information data transmitting device 110 (Step S302). The portable information data transmitting device 110 has at least one external selection means which is operated to select a specific provision method for providing the information data stored in the portable information data transmitting device 110.

On the basis of the input signal recognized in Step S302, when the selection of the first provision method is confirmed, the portable information data transmitting device 110 extracts all the information data stored in the memory 200, and generates electric signals by modulating the information data (S304).

The portable information data transmitting device 110 flashes the light emitting elements 212, and converts the electric signals generated in Step S304 by modulating the information data into visible light signals (S306).

The portable information data transmitting device 110 transmits the converted visible light signal in Step S306 to the display device 120 (S308).

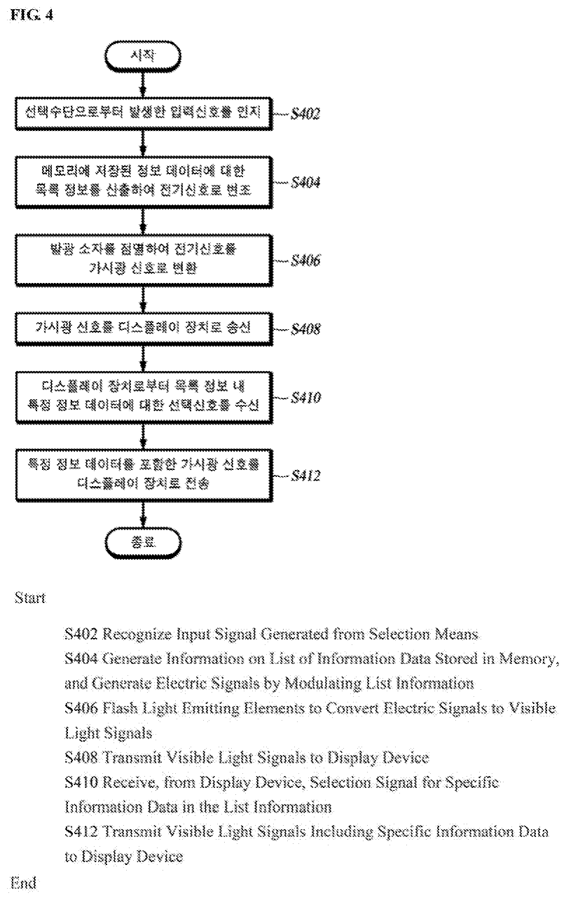

FIG. 4 is a flowchart of a second method performed by a portable information data transmitting device, for providing information data according to at least one embodiment.

The portable information data transmitting device 110 recognizes an input signal generated from selection means provided on the portable information data transmitting device 110 (S402).

On the basis of the input signal recognized in Step S402, when the selection of the second provision method is confirmed, the portable information data transmitting device 110 calculates information on the list of the information data stored in the memory 200, and generates electric signals by modulating the list information (S404).

The mobile information data transmitting apparatus 110 flashes the light emitting elements 212, converts the electric signals generated in Step S404 by modulating the information data into visible light signals (S406), and transmits the converted visible light signals to the display device 120 (S408).

The portable information data transmitting device 110 receives, from the display device 120, a selection signal for specific information data in the information on the list of information data (S410). In Step S410, it is preferable that the portable information data transmitting device 110 receives the aforementioned selection signal by using visible light communication from the display device 120, but it is not necessarily limited thereto.

The portable information data transmitting device 110 calculates specific information data in the memory 200, corresponding to the selection signal received in Step S410, and generates a visible light signal including the specific information data, to transmit the visible light signal to the display device 120 (S412).

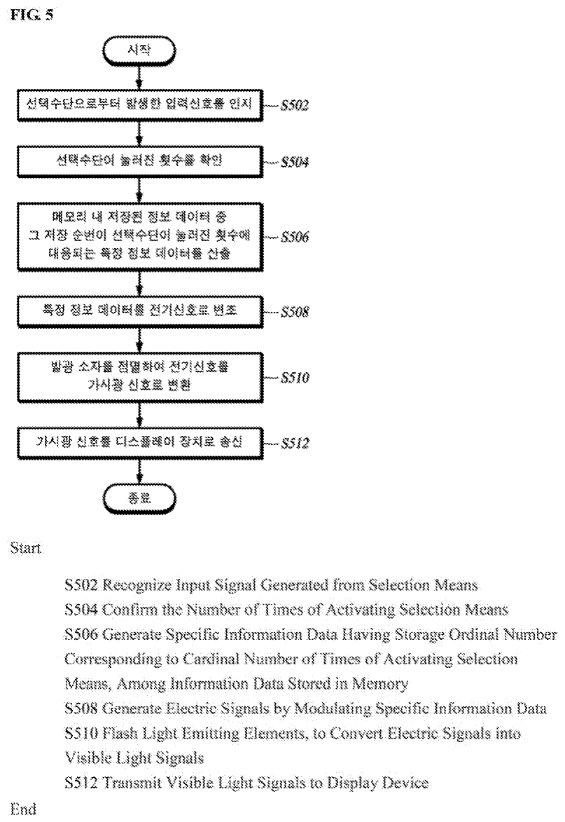

FIG. 5 is a flowchart of a third method performed by a portable information data transmitting device, for providing information data according to at least one embodiment.

The portable information data transmitting device 110 recognizes the input signal generated from the selection means provided on the portable information data transmitting device 110 (S502).

On the basis of the input signal recognized in Step S502, when the selection of the third provision method is confirmed, the portable information data transmitting device 110 confirms the number of times of activating the selection means (S504). In Step S504, the portable information data transmitting device 110 may check the number of times of activating the selection means by counting the number of input signals recognized in Step S502.

The portable information data transmitting device 110 calculates specific information data having a storage ordinal number corresponding to the cardinal number of times of activating the selection means as confirmed in Step S504, among the stored information data in the memory 200 (S506). For example, when the cardinal number of times of activating the selection means is three, the portable information data transmission apparatus 110 transmits the information data whose storage order is the third among the stored information data in the memory 200.

The portable information data transmitting device 110 generates electric signals by modulating the specific information data calculated in Step S506 (S508).

The portable information data transmitting device 110 flashes the light emitting elements 212, converts the electric signals generated in Step S508 by modulating the information data into visible light signals (S510), and transmits the converted visible light signals to the display device 120 (S512).

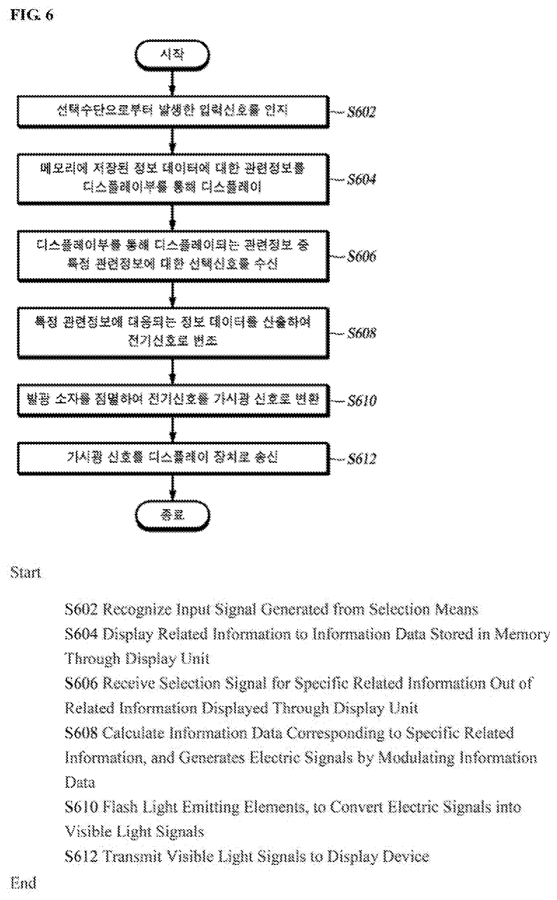

FIG. 6 is a flowchart of a fourth method performed by a portable information data transmitting device, for providing information data according to at least one embodiment.

The portable information data transmitting device 110 recognizes an input signal generated from the selection means provided on the portable information data transmitting device 110 (S602).

On the basis of the input signal recognized in Step S602, when the fourth provision method is confirmed to be selected, the portable information data transmitting device 110 displays related information to the information data stored in the memory 200 through the display unit 240 (S604). In Step S604, the portable information data transmitting device 110 generates an image of the related information displayed through the display unit 240, and transmits the generated image to the display device 120 through visible light communication as well.

When the portable information data transmitting device 110 receives a selection signal for specific related information out of the related information displayed in Step S604 (S606), it calculates information data in the memory 200, which corresponds to the specific related information, and generates electric signals by modulating the information data (S608).

The portable information data transmitting device 110 flashes the light emitting elements 212, converts the electric signals generated in Step S608 by modulating the information data into visible light signals (S610), and transmits the converted visible light signals to the display device 120 (S612).

Although exemplary embodiments of the present disclosure have been described for illustrative purposes, those skilled in the art will appreciate that various modifications, additions and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### CROSS-REFERENCE TO RELATED APPLICATION

This application claims priority under 35 U.S.C § 119(a) of Patent Application No. 10-2016-0045031, filed on Apr. 12, 2016 in Korea, the entire content of which is incorporated herein by reference. In addition, this non-provisional application claims priority in countries, other than the U.S., with the same reason based on the Korean patent application, the entire content of which is hereby incorporated by reference.

1. A portable information data transmitting device, comprising:
a memory configured to store at least one piece of information data;
a light emitting unit configured to include a plurality of light emitting elements, and to transmit visible light signals including some or all of the information data to a display device located within a predetermined communication range by using the light emitting elements; and
a control unit configured to control the light emitting elements for causing the visible light signals to be transmitted to the display device.

2. The portable information data transmitting device of claim 1, wherein
the portable information data transmitting device comprises a main body shaped as a flashlight, and
the control unit is configured to control the light emitting elements to emit light of a predetermined intensity for enabling the portable information data transmitting device to serve as a flashlight.

3. The portable information data transmitting device of claim 2, wherein
the portable information data transmitting device comprises a mode switcher configured to switch use of the portable information data transmitting device to function as a flashlight or information data transmitter, and
the control unit is configured to differentially control operations of the light emitting elements according to the use of the portable information data transmitting device as determined by the mode switcher.

4. The portable information data transmitting device of claim 1, comprising:
at least one selector configured to be provided on an outer surface of the portable information data transmitting device, for selecting a data provision method for providing the information data.

5. The portable information data transmitting device of claim 4, wherein the control unit is configured to cause, according to the data provision method selected by the selector, visible light signals including all of the information data stored in the memory to be transmitted to the display device.

6. The portable information data transmitting device of claim 4, wherein the control unit is configured to cause, according to the data provision method selected by the selector, a visible light signal including information on a list of information data stored in the memory to be transmitted to the display device.

7. The portable information data transmitting device of claim 6, wherein the control unit is configured to cause, in response to a receipt of a selection signal for a specific information data within the information on the list, a visible light signal including the specific information data to be transmitted to the display device.

8. The mobile information data transmission apparatus of claim 4, wherein the control unit is configured to generate, according to the data provision method selected by the selector, a specific information data having a storage ordinal number corresponding to a cardinal number of times of activating the selector, among the information data stored in the memory, and to control to transmit a visible light signal including the specific information data to the display device.

9. The portable information data transmitting device of claim 4, further comprising a display unit on an outer surface of the portable information data transmitting device, and
wherein the control unit is configured to cause, according to the data provision method selected by the selector, related information which is related to the information data stored in the memory to be displayed through the display unit.

10. The portable information data transmitting device of claim 9, wherein the control unit is configured to cause, in response to a receipt of a selection signal for a specific related information out of the related information that are displayed through the display unit, a visible light signal including the information data corresponding to the specific related information, to be transmitted to the display device.

11. The portable information data transmitting device of claim 9, wherein the control unit is configured to transmit a visible light signal arranged to carry an image of the related information displayed through the display unit, to the display device.

12. A system for displaying information data by using visible light communication, the system comprising:
a portable information data transmitting device configured to store at least one piece of information data, and to include a plurality of light emitting elements for transmitting visible light signals including some or all of the information data; and
a display device configured to receive the visible light signals from the portable information data transmitting device, and to display the information data included in the visible light signals to a user.
